(19) United States
(12) Patent Application Publication
(10) Pub. No.: US 2016/0306613 A1
(43) Pub. Date: Oct. 20, 2016

(54) CODE ROUTINE PERFORMANCE PREDICTION USING TEST RESULTS FROM CODE INTEGRATION TOOL

(71) Applicant: HEWLETT PACKARD ENTERPRISE DEVELOPMENT LP, Houston, TX (US)

(72) Inventors: Eliraz Busi, Yehud (IL); Doron Levi, Yehud (IL); Oren Gurfinkel, Yehud (IL)

(21) Appl. No.: 15/101,111

(22) PCT Filed: Dec. 3, 2013
(86) PCT No.: PCT/US2013/072725

§ 371 Date: Jun. 2, 2016

(51) Int. Cl. G06F 9/44; G06F 11/36

(52) U.S. Cl. CPC G06F 8/36; G06F 11/3668; G06F 8/71

(57) ABSTRACT

Example embodiments relate to code routine performance prediction using test results from code integration tool. An example system may include
a code integrator to merge multiple developer committed copies of code for an application and automatically run tests on the merged code. The code integrator may gather performance information of a pre-written code routine included in the merged code, where the performance information is generated in response to the tests. The system may include a code routine performance manager to receive and store the performance information of the pre-written code routine. The system may include a code development environment to allow a developer of the application to create and modify a working copy of code for the application. The code development environment may receive the performance information of the pre-written code routine when the pre-written code routine is included in the working copy of the code.

### BACKGROUND

When a software application developer (developer for short) writes an application, the developer may make extensive use of pre-written code routines (e.g., methods, API's, etc.), for example, code routines provided by other teams inside the same organization as the developer or code routines provided by third parties.

Code Integration is the practice, in software development, of merging multiple developer committed copies of code for a software application and running various tests (e.g., automation tests, integration tests, unit tests, system tests, etc.) on the merged code. The term continuous integration (CI) may refer to code integration that happens regularly and often, for example, several times a day.

### BRIEF DESCRIPTION OF THE DRAWINGS

The following detailed description references the drawings, wherein:

FIG. 1 is a block diagram of an example computing environment in which code routine performance prediction using test results from a code integration tool may be useful;

FIGS. 2A and 2B depict an example graphical user interface for an example code development module for code routine performance prediction using test results from a code integration tool;

FIG. 3 is a flowchart of an example method for code routine performance prediction using test results from a code integration tool;

FIG. 4 is a block diagram of an example system for code routine performance prediction using test results from a code integration tool;

FIG. 5 is a flowchart of an example method for code routine performance prediction using test results from a code integration tool; and

FIG. 6 is a block diagram of an example code routine performance management system for event-driven automation testing using test results from a code integration tool.

### DETAILED DESCRIPTION

Many developers use various pre-written code routines (e.g., methods, API's, etc.) without being aware of the performance implications of using such code routines, for example, the amount of time that the code routine may consume, the amount of memory that the code routine may consume and the like. Moreover, various code routines may behave differently in different use cases. Developers may be unaware of the performance implications of various code routines because they do not have easy access to code routine performance information and/or easy access at useful times (e.g., during the coding phase). Even for advanced organizations that implement formal code development processes (e.g., Agile), determining and keeping track of performance information for a large number of code routines is a challenge, for at least the reason that performance may be impacted for various reasons. The lack of code routine performance information may prevent developers from creating efficient, optimized and problem-free applications. Performance degradations that are latent in an application's code may be very complex and expensive to detect and fix in later stages. For example, a full scale investigation may include building dedicated task forces, creating data profiles, using profilers and log analysis, and evaluating the possible impact. In the end, such a task force may realize that a single call to a code routine was causing the performance degradations. At that point, it may be too late to make architectural changes or to approach the writer of the code routine. Thus, it may be desirable for developers to have access to code routine performance information early on in the development process, and it may be desirable for such code routine performance information to be rich and accurate in relation to the developers planned usage.

Various code analysis rules exist that may be implemented in some code development environments, but these code analysis rules check for basic code performance issues (e.g., whether all variable are defined, whether particular error checks were included in the code, etc.). Some code analysis rules check for basic performance based issues, but such checks are generic and do not consider actual performance statistics of pre-written code routines. Various code profilers exist that may analyze a computer program to determine various performance aspects of the program (e.g., memory used, run time, complexity, etc.). However, such profilers may analyze an entire code base (i.e., all the source code) and may produce large amounts of raw performance data and it may not be the type of performance data that is useful to an application developer at the time of programming.

The present disclosure describes code routine performance prediction using test results from a code integration tool. The present disclosure describes gathering performance information of pre-written code routines from tests run by a code integrator, where the code integrator runs tests (e.g., automation tests, integration tests, unit tests, system tests, etc.) on merged code for an application that is based on multiple developer committed copies of the code.

The present disclosure further describes a code routine performance manager to receive and store the performance information of various pre-written code routines. The present disclosure further describes indicating code routine performance information in a code development environment (e.g., an IDE) to allow a developer of the application to determine (e.g., on the fly) the implications of using various code routines in the developer's code. The performance information gathered from the code integration tool may be categorized (e.g., based on different use cases) to provide rich information that may be tailored to the developers particular use situation, thereby providing performance information that is accurate in relation to the developers planned usage. By having access to code routine performance information early on in the development process (at the coding phase), a developer may produce efficient, optimized and problem-free applications.

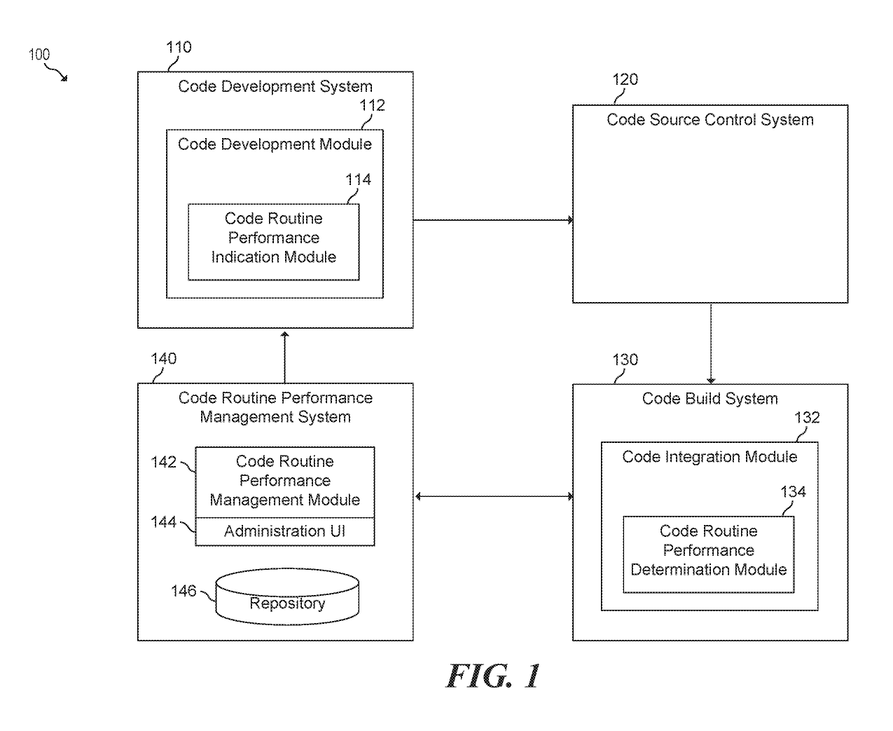

FIG. 1 is a block diagram of an example computing environment 100 in which code routine performance prediction using test results from a code integration tool may be useful. Computing environment 100 may include at least one code development system (e.g., 110), a code source control system 120, a code build system 130 and a code routine performance management system 140. It should be understood that although FIG. 1 and various descriptions herein may indicate only a single code development system (e.g., 110), more than one more than one code development system may be in communication with code source control system 120 and code routine performance management system 140, and these additional code development systems may be similar to code development system 110. The components (e.g., 110, 120, 130, 140) of computing environment 100 may each be in communication with at least one of the other components, for example, as indicated by arrows in FIG. 1. These communications may be performed over at least one network, for example, any wired or wireless network. Each network may include any number of hubs, routers, switches or the like. Each network may be, for example, part of the internet, part of an intranet and/or other type of network. The network that allows for communication between two components (e.g., 110, 120) of environment 100 may be the same or a different network than the network that allows for communication between two other components (e.g., 110, 140).

Computing environment 100 may generally depict an environment used in a code development process (e.g., for a software application). For example, an application developer may communicate with code development system 110 to write or modify a copy of code for an application. Via code development system 110, the developer may commit the copy of the code to code source control system 120, where multiple developer committed copies of code for the application may be merged or integrated into a single merged code. At various times, code build system 130 may pull the merged code from code source control system 120 and may build the code and run tests (e.g., integration tests) on the code. According to the present disclosure, as may be described in more detail below, code routine performance determination module 134 may monitor the execution of various code routines that are run based on the tests, and may send such performance information to code routine performance management system 140, where such performance information may be stored. Code development system 110 may then display (e.g., via module 112 and 114) performance information of various code routines to the developer when such code routines are included in the developer's code. The code development process described above may allow for dynamic, real time or continuous recalibration or feedback of performance information as developers commit new copies of code to code source control system 120, and as the code build system 130 runs tests on the new merged code, and as new performance information is collected, sent to code routine performance management system 140 and in turn, sent back to code development system 110.

Code source control system 120 may track various versions of source code (e.g., for a software application) and may provide control over changes to that source code. Code source control system 120 may receive committed copies of code from various code development systems (e.g., 110), and may determine whether any conflicts exist. Code source control system 120 may then merge multiple received committed copies of code into a new merged version of the source code, e.g., to create a new master version of the source code. This version of the code may then be tested.

Code build system 130 may be a build server or the like. Code build system 130 may receive notifications when new versions of code for an application have been committed to code source control system 120. Code build system 130 may then trigger or initiate a build of the code for testing (e.g., to keep the code base integrated and functionally tested). The building and executing of the code may be performed by module 132 as described in more detail below. Code build system 130 may act as a sort of orchestrator or scheduler to initiate builds, for example, determining what code to build, when to start builds (e.g., every hour, every night, etc.), what order various jobs should be run in, etc. Code build system 130 may pull merged code from code source control system 120 and indicate to code integration module 132 when to start a build/testing.

Code build system 130 may be at least one computing device that is capable of communicating with a code source control system (e.g., 120) and a code routine performance management system (e.g., 140) over at least one network. In some embodiments of the present disclosure, code build system may include more than one computing device. In other words, the components shown in code build system 130 (e.g., code integration module 132) in FIG. 1 may be, but need not be, distributed across multiple computing devices, for example, computing devices that are in communication with each other via a network. In these embodiments, the computing devices may be separate devices, perhaps geographically separate. Thus, the term “system” may be used to refer to a single computing device or multiple computing devices that operate together to provide a service. In some embodiments, cod source control system 120 and code build system 130 may be implemented on the same computing device.

Code integration module 132 may compile and build the merged or master code that code build system 130 pulled from code source control system 120. Code integration module 132 may automatically perform such compiling and build, e.g., after the merged code is received. Code integration module 132 may, in some examples, be a continuous integration (CI) module, for example, if module 132 builds and tests the code regularly and often, e.g., several times a day. In some specific examples, code integration module 132 may be a CI agent such as Jenkins slave machine, HP ALM SSE/CSE agent or the like. Code integration module 132 may run various tests on the code to check whether any of the code is broken or not functioning properly or optimally. Code integration module 132 may automatically run such tests, e.g., after the merged code is compiled and built. Code integration module 132 may run, for example, automation tests, integration tests, unit tests, system tests and the like. The tests being run by code integration module 132 may be tests that are to be run in the normal course of the development process described above and shown in FIG. 1. Thus, it may be the case that even if code routine performance determination module 134 was not included, for example, these tests may still be run to test the functionality of the merged or master code base. Code routine performance determination module 134 may then leverage these planned or existing tests to extract performance information. Skilled test engineers may expend large amounts of resources to develop these tests in order to test many portions of the application code in many different scenarios. By leveraging these tests, code routine performance determination module 134 may have access to rich and interesting testing results.

Code integration module 132 may include a series of instructions encoded on a machine-readable storage medium of code build system 130 and executable by a processor of code build system 130. In addition or as an alternative, code integration module 132 may include one or more hardware devices including electronic circuitry for implementing the functionality described below.

Code routine performance determination module 134 may be installed and/or may run on the same computing device as code integration module 132. Code routine performance determination module 134 may access tests that are run by code integration module 132. As described above, these tests may be rich and interesting because of the testing resources expended to create them. In particular, code routine performance determination module 134 may monitor the behavior of various code routines (e.g., methods, API's, etc.) during these tests or based on the test results.

Code routine performance determination module 134 may receive configuration information from code routine performance management system 140 (e.g., from module 142). Module 134 may “listen” for such configuration information when it is sent from system 140, or module 134 may perform a “get” type call to system 140 to retrieve the configuration information. Code routine performance determination module 134 may determine, based on this configuration information, how to monitor various tests and code routines run by code integration module 132. For example, the configuration information may indicate which code routines module 134 should monitor and/or which tests module 134 should gather performance information from. Because module 134 may only monitor certain tests and code routines, module 134 may run with minimal overhead and may only collect performance information that is relevant, e.g., relevant to developers in the code stage. This is one example benefit over various code profilers that may analyze the entire code base and my collect massive amounts of performance information.

Code routine performance determination module 134 may collect performance information from the code routines and tests that module 134 analyzes (e.g., based on the configuration information). Module 134 may collect this information using at least one diagnostic tool (e.g., HP diagnostics probe). Examples of the type of data module 134 may collect include the number of calls made to a particular code routine and the amount of time it took the code routine to execute. As one specific example, assume an API method is named “GetUserInformation,” and assume module 134 is instructed to monitor this API method based on configuration information received from system 140. Assume that the API method is invoked during a login process as part of a test run by code integration module 132. Module 134 may analyze the test and the execution of the GetUserInformation method and may determine that it took the method 5323 ms to run in this “login” use case. Module 134 may then store the information, for example, as shown in Table 1 below.

TABLE 1

| | Use | Avg. | Max | Min | Number | Standard |
|---|---|---|---|---|---|---|
| Code Routine | Case | (msec) | (msec) | (msec) | of Calls | Deviation |
| GetUse- | Login | 5323 | 5323 | 5323 | 1 | 0 |
| Information | | | | | | |

Of course, as the GetUserInformation method is run more time and analyzed by module 134, the information in Table 1 may be updated and may include a higher number of calls, and more interesting average, maximum and minimum execution time statistics.

Code routine performance determination module 134 may categorize performance information received, to provide rich information that may be tailored to developers' particular use situations. For example, the performance information gathered from the code integration tool may be categorized based on different use cases. In this respect, developers may be provided with performance information that is accurate in relation to the developers planned usage. Code routine performance determination module 134 may send or push performance information (e.g., organized and/or categorized performance information) to system 140 (e.g., to module 142). Module 134 may send such performance information soon after it is collected or module 134 may collect a certain amount of information and then send it to system 140 as a collection of performance information. In one particular example, module 134 may collect performance information from a complete integration build and test cycle, and may send such information to system 140 as a bundle.

Code routine performance determination module 134 may include a series of instructions encoded on a machine-readable storage medium of code build system 130 and executable by a processor of code build system 130. In addition or as an alternative, code routine performance determination module 134 may include one or more hardware devices including electronic circuitry for implementing the functionality described below.

Code routine performance management system 140 may provide configuration information (e.g., configuration information entered by an administrator via UI 144) to module 134 and may receive and store performance information from module 134. Code routine performance management system 140 may be at least one computing device that is capable of communicating with a code build system (e.g., 130) and at least one code development system (e.g., 110) over at least one network. In some embodiments of the present disclosure, code routine performance management system 140 may include more than one computing device. In other words, the components shown in system 140 (e.g., module 142 and repository 146) in FIG. 1 may be, but need not be, distributed across multiple computing devices, for example, computing devices that are in communication with each other via a network. In these embodiments, the computing devices may be separate devices, perhaps geographically separate. Thus, the term “system” may be used to refer to a single computing device or multiple computing devices that operate together to provide a service. Code routine performance management system 140 may include a code routine performance management module 142, an administration UI 144 and at least one repository (e.g., 146).

Code routine performance management module 142 may provide configuration information to module 134, e.g., as described in some detail above. Such configuration information may include a list of code routines (e.g., API's, methods, etc.) that module 134 should monitor/analyze. As a specific example, module 142 may maintain a list of classes, namespaces and the like that module 134 should monitor/analyze. After module 142 sends such configuration information to module 134, module 142 may receive, after some time, performance information for the specified code routines, perhaps in various manners (e.g., by use case). Code routine performance management module 142 may store performance information received from module 134. In some examples, module 142 may be in communication with a repository (e.g., 146) that stores the collected performance information. The term repository may generally refer to a data store that may store digital information. A repository may include or be in communication with at least one physical storage mechanism (e.g., hard drive, solid state drive, tap drive or the like) capable of storing information including, for example, a digital database, a file capable of storing text, media, code, settings or the like, or other type of data store.

Code routine performance management module 142 may include a set of performance rules, for example, thresholds for various executions times (e.g., what constitutes “fast,” “medium,” or “slow” execution), thresholds for number of times code routines are called (e.g., what constitutes “low,” “medium,” or “high” number of calls), and the like. Various thresholds may be used to determine, for example, when an issue with a developer's code may be a warning or a critical issue. Other rules may indicate (e.g., to a code development system 110) when various warnings may be ignored, for example, whether developers may suppress issues that are only classified as warnings and not critical issues. These rules may be used to implement various policies, standards or best practices of an organization, for example, policies on acceptable execution speeds or the like.

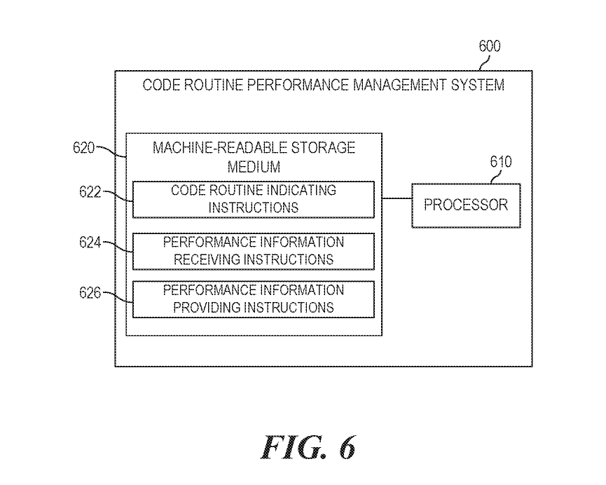

Code routine performance management module 142 may include or be in communication with an administration UI (user interface) 144, which may allow an administrator to communicate with module 142. Via UI 144, an administrator may create or configure at least one list of tests and/or code routines that should be monitored by module 134. Via UI 144, an administrator may create or configure at least one performance rule (e.g., performance rules described above). Code routine performance management module 142 and/or administrator UI 144 may each include a series of instructions encoded on a machine-readable storage medium (e.g., 620 of FIG. 6) of code routine performance management system 140 and executable by a processor (e.g., 610 of FIG. 6) of code routine performance management system 140. In addition or as an alternative, code routine performance management system 140 may include one or more hardware devices including electronic circuitry for implementing the functionality described herein.

Code routine performance management module 142 may provide performance information of various code routines to at least one code development system (e.g., 110), for example, to an included code routine performance indication module 114. In this respect, module 142 may alert (e.g., via module 112 and 114) developers to various performance implications of their usage of various code routines. Additionally, module 142 may provide performance information that is categorized such that developers may be provided with performance information that is accurate in relation to the developers planned usage. Additionally, module 142 may provide performance rules (described above), for example, performance rules that may be used to implement various policies, standards or best practices of an organization.

Code development system 110 may allow developers to write code (e.g., a working copy of code) for a software application. Code development system 110 may allow developers to commit copies of code to code source control system 120. Code development system 110 may any computing device that is capable of communicating with a code routine performance management system (e.g., 140) and a code source control system 120 over at least one network. In some embodiments, code development system 110 may include a code development module 112.

Code development module 112 may run on system 110, for example, to allow developers to write code. In some examples, code development module 112 may be an integrated development environment (IDE) or interactive development environment that provides comprehensive functionality to developers to write code for software applications. Code development module 112 may include a series of instructions encoded on a machine-readable storage medium of code development system 110 and executable by a processor of code development system 110. In addition or as an alternative, code development module 112 may include one or more hardware devices including electronic circuitry for implementing the functionality described herein.

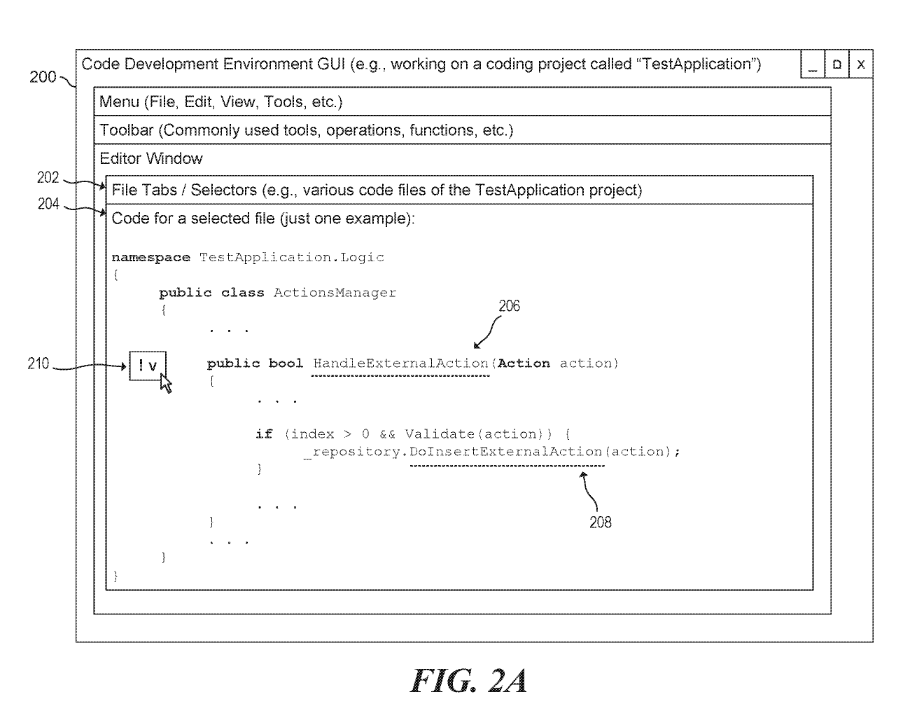

Code development module 112 may provide a developer with a graphical user interface (GUI) that allows the developer to create and modify code. For example, module 112 may provide a GUI similar to GUI 200 shown in FIGS. 2A and 2B. GUI 200 may provide to the developer (e.g., at section 202) access to various code files that are part of a project (e.g., for an application). At section 204, GUI 200 may provide access to a particular selected code file, such that the developer may, for example, modify the code included in the file. FIGS. 2A and 2B show, in section 204, example code in an example code file for a project called “TestApplication.” More information about how a developer may edit code in section 204 and may be provided with performance information of various code routines may be described in more detail below. Code development module 112 may include a code routine performance indication module 114.

Code routine performance indication module 114 may provide a developer with alerts, warnings and the like related to various code routines that the developer includes in the developer's code. Code routine performance indication module 114 may be integrated into code development module 112 (e.g., as a plugin of sorts). Code routine performance indication module 114 may include a series of instructions encoded on a machine-readable storage medium of code development system 110 and executable by a processor of code development system 110. In addition or as an alternative, code routine performance indication module 114 may include one or more hardware devices including electronic circuitry for implementing the functionality described herein.

Code routine performance indication module 114 may receive collected performance information about various code routines and various rules from system 140. Module 114 may “listen” for such performance information when it is sent from system 140, or module 114 may perform a “get” type call to system 140 to retrieve the performance information. Code routine performance indication module 114 may receive performance information for various code routines and rules at various times. For example, module 114 may receive performance information for several code routines in advance in case they are included in the developer's code. As another example module 114 may get (e.g., using a “get” function) performance information for a code routine from system 140 on the fly as soon as module 114 detects that the particular code routine was included in the code.

Code routine performance indication module 114 may understand and enforce the received rules. For example, module 114 may understand that a code routine used in a particular use case that has an execution time that falls within a certain range should generate a “warning” to the developer. As another example, module 114 may understand that a code routine used a certain number of times in a particular code base should generate a critical issue to the developer. As another example, module 114 may recognize that a code routine execution time in a particular use case is considered “slow,” or that multiple calls to the same code routine may cause a potential performance bottleneck. Additionally, as mentioned above, performance information may be categorized (e.g., by use case), and thus module 114 may recognize that a particular code routine may run in X (e.g., a decimal number) seconds in one use cases, and Y seconds in another use case. Thus, by detecting the developers particular use situation, module 114 may tailor alerts and warnings to the developer's particular situation.

Code routine performance indication module 114 may provide a developer with dynamic or real-time alerts and warnings, e.g., as the developer types code (e.g., adds a call to a problem code routine or closes a method that includes a problem code routine). In this respect, alerts and warnings may be provided to the developer on the fly when the pre-written code routine is included in the code or shortly after. This may provide one example benefit over various code profilers that may analyze the entire code base, for example, after the developer has written a large chunk of code. Code routine performance indication module 114 may alert the developer to various performance implications of a code routine included in the developer's code. Code routine performance indication module 114 may statically analyze/parse the code written by the developer to detect the usage of particular code routines. For example, code routine performance manager 142 may provide a list of code routines that module 114 should watch for. When such a routine is detected, the performance information and various rules for that routine may be recalled, for example, from local memory in code development system or on demand from system 140. If the performance information and rules indicate any issues (e.g., slow code routines), module 114 may alert the developer.

Code routine performance indication module 114 may provide performance information to the developer as code analysis rule violations. In some examples, the performance information and various established rules may be provided to the developer by extending code analysis tools (e.g., existing code analysis tools), for example, PMD for Java and FxCop for C Sharp and ReSharper. In this respect, module 114 in conjunction with module 112 and perhaps an existing code analysis tool may run various tests on code entered by a developer. The tests may be run on the fly, e.g., as the developer enters the code. Then, the developer may be presented with a list of rules the developer violate, including rules related to the received code routine performance information.

FIGS. 2A and 2B show one example of how performance issues may be displayed to a developer. Module 114 in conjunction with module 112 may cause performance issues and alerts to be visualized for developers. GUI 200 was generally explained above. Now, assume that the developer is entering code, for example, the content of the “HandleExternalAction” method (indicate by reference number 206). Assume further that the developer enters a call to the “DolnsertExternalAction” method, shown at reference number 208. Soon after (e.g., after the “HandleExternalAction” method is closed, or sooner) the developer includes the call to the “DolnsertExternalAction” method, module 114 may recall performance information for the “DolnsertExternalAction” method, and may indicate potential performance issues with this method. In the example of FIG. 2A, an icon (e.g., 210) may appear in the coding section 204 to alert the developer to an issue. The developer may then click on the icon to see alerts and warnings associated with the icon. When the developer clicks on the icon, a message box (e.g., 212) may appear, for example, as can be seen in FIG. 2B. The message box may display various issues with the inclusion of the “DolnsertExternalAction” method, for example, a warning that adding a call to this method may cause performance degradation because this is an excessively used method in the current coding structure.

Once a developer see such alerts and warnings, the developer can immediately fix the code (at the coding phase), e.g., to comply with particular rules. For example, a developer could remove complex and heavy code routines or move them into different execution threads. As another example, a developer could select between comparable code routines, e.g., choosing to use lightweight methods for interactive user interfaces. A developer could also analyze any code routines that are used in a central or heavily used method. As yet another example, a developer could choose to cache certain results or make other design changes to deal with a code routine that takes a long time to execute.

If the developer does not or cannot comply with the alert or warning, an indication may be entered into the build log as with any other code rule violation. Then, project engineers can gain insight and proactively engage developers to fix code routines that may be causing issues, or alternately, suppress these errors if no solution is found (e.g., in a particular release). Developers can also compare performance snapshots between builds of their own code or project engineers can compare performance snapshots between code drops.

Referring again to FIG. 1, in some embodiments of the present disclosure, code routine performance indication module 114 may be implemented in code integration module 132, e.g., in addition to or as an alternative to being implemented in code development module 112. For example, by being implemented in code integration module 132, module 114 may assist module 132 to determine whether a merge copy of code received from system 120 violates any rules or uses any slowly executing code routines. In a similar manner to that explained above, in this situation, module 114 may receive performance information and various rules from system 140.

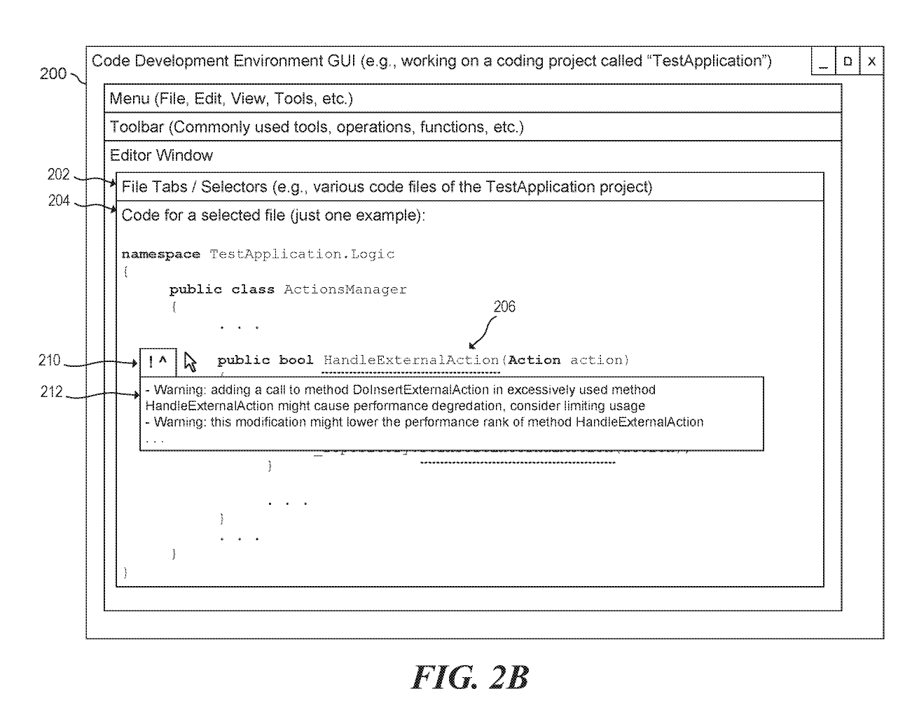

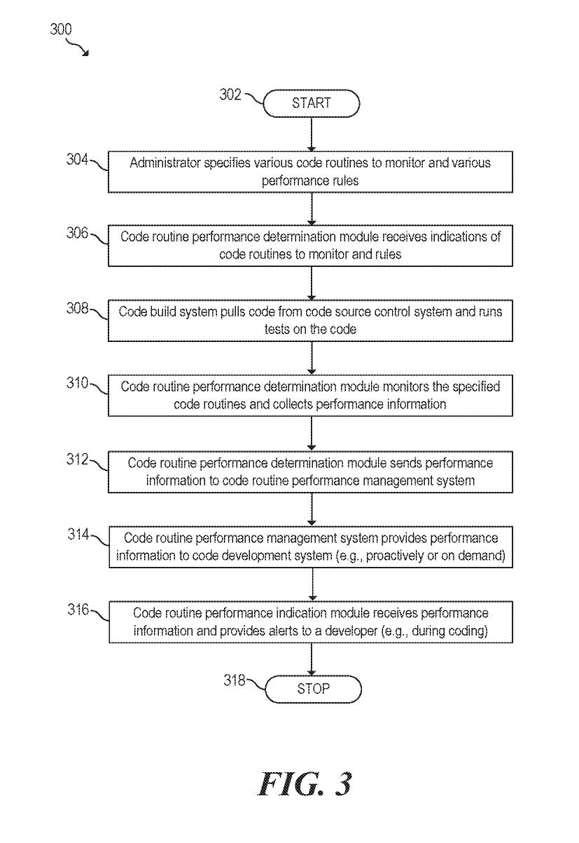

FIG. 3 is a flowchart of an example method 300 for code routine performance prediction using test results from a code integration tool. The execution of method 300 is described below with reference to a code routine performance management system (e.g., similar to 140 of FIG. 1), a code build system (e.g., similar to 130), and a code development system (e.g., similar to 110). Various other suitable computing devices or systems may execute part or all of method 300, for example, system 400 of FIG. 4. Method 300 may be implemented in the form of executable instructions stored on at least one machine-readable storage medium (e.g., 620 of FIG. 6) and/or in the form of electronic circuitry. In alternate embodiments of the present disclosure, one or more steps of method 300 may be executed substantially concurrently or in a different order than shown in FIG. 3. In alternate embodiments of the present disclosure, method 300 may include more or less steps than are shown in FIG. 3. In some embodiments, one or more of the steps of method 300 may, at certain times, be ongoing and/or may repeat.

Method 300 may start at step 302 and may continue to step 304, where an administrator may specify (e.g., via system 140, module 142 and/or UI 144) various code routines to monitor and various performance rules. At step 306, a code routine performance determination module (e.g., 132) included in a code build system (e.g., 130) may receive (e.g., from system 140) indications of the code routines to monitor and the rules. At step 308, the code build system may pull code from a code source control system (e.g., 120) and run tests on the code. At step 310, the code routine performance indication module may monitor the specified code routines during the running of the tests and collect performance information. At step 312, the code routine performance indication module may send performance information to the code routine performance management system (e.g., 140). At step 314, the code routine performance management system may provide the performance information to a code development system (e.g., 110). The performance information may be provided proactively (e.g., in case it is needed) or on-demand (e.g., when a developer enters code via a code development module such as 112). At step 316, a code routine performance indication module (e.g., 114) may receive the performance information and may provide alerts and/or warnings to the developer (e.g., during the coding phase). Method 300 may eventually continue to step 318, where method 300 may stop.

FIG. 4 is a block diagram of an example system 400 for code routine performance prediction using test results from a code integration tool. System 400 may include any number of computing devices, e.g., computing devices that are capable of communicating with each other over a network. In the embodiment of FIG. 4, system 400 includes a code integrator 410, a code routine performance manager 420 and a code development environment 430. Code integrator 410 may be similar to code integration module 132 of FIG. 1. Code integrator 410 includes one or more hardware devices including electronic circuitry for implementing the functionality of code integrator 410. Code integrator 410 may also include a series of instructions executable by the one or more hardware devices of code integrator 410. Code integrator 410 may merge multiple developer committed copies of code for an application and automatically run tests on the merged code. Code integrator 410 may gather performance information of a pre-written code routine included in the merged code, where the performance information may be generated in response to the tests.

Code routine performance manager 420 may be similar to code routine performance management module 142 of FIG. 1. Code routine performance manager 420 includes one or more hardware devices including electronic circuitry for implementing the functionality of code routine performance manager 420. Code routine performance manager 420 may also include a series of instructions executable by the one or more hardware devices of code routine performance manager 420. Code routine performance manager 420 may receive and store the performance information of the pre-written code routine. Code development environment 430 may be similar to code development module 112 of FIG. 1. Code development environment 430 includes one or more hardware devices including electronic circuitry for implementing the functionality of code development environment 430. Code development environment 430 may also include a series of instructions executable by the one or more hardware devices of code development environment 430. Code development environment 430 may allow a developer of the application to create and modify a working copy of code for the application. Code development environment 430 may receive the performance information of the pre-written code routine when the pre-written code routine is included in the working copy of the code.

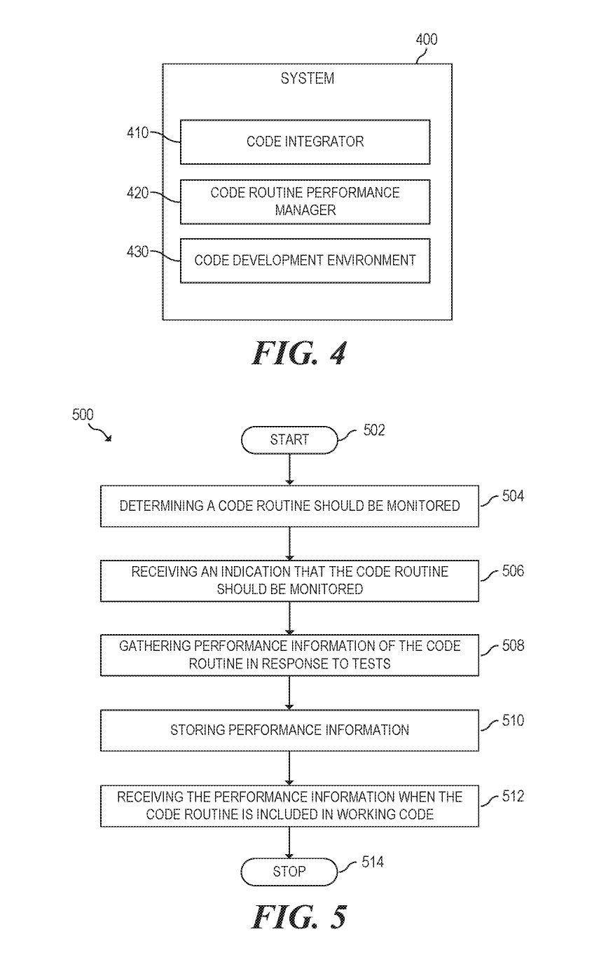

FIG. 5 is a flowchart of an example method 500 for code routine performance prediction using test results from a code integration tool. Method 500 may be described below as being executed or performed by components of a system, for example, system 400 of FIG. 4. Other suitable systems/components may be used as well, for example, the components shown in FIG. 1. Method 500 may be implemented in the form of executable instructions stored on at least one machine-readable storage medium of the system, and/or in the form of electronic circuitry. In alternate embodiments of the present disclosure, one or more steps of method 500 may be executed substantially concurrently or in a different order than shown in FIG. 5. In alternate embodiments of the present disclosure, method 500 may include more or less steps than are shown in FIG. 5. In some embodiments, one or more of the steps of method 500 may, at certain times, be ongoing and/or may repeat.

Method 500 may start at step 502 and continue to step 504, where a system may determine, at a code routine performance manager, that a pre-written code routine should be monitored. At step 506, the system may receive, at a code integrator, an indication that the pre-written code routine should be monitored. The code integrator may merge multiple developer committed copies of code for an application and automatically run tests on the merged code. The merged code may include the pre-written code routine. At step 508, the system may gather, at the code integrator, performance information of the pre-written code routine. The performance information may be generated in response to the tests. At step 510, the system may receive and store, at the code routine performance manager, the performance information of the pre-written code routine. At step 512, they system may receive, at a code development environment, the performance information of the pre-written code routine when the pre-written code routine is included in a working copy of the code. Method 500 may eventually continue to step 514, where method 500 may stop.

FIG. 6 is a block diagram of an example code routine performance management system 600 for event-driven automation testing using test results from a code integration tool. System 600 may be similar to system 140 of FIG. 1, for example. System 600 may be any number of computing devices. In the embodiment of FIG. 6, system 600 includes a processor 610 and a machine-readable storage medium 620.

Processor 610 may be one or more central processing units (CPUs), microprocessors, and/or other hardware devices suitable for retrieval and execution of instructions stored in machine-readable storage medium 620. In the particular embodiment shown in FIG. 6, processor 610 may fetch, decode, and execute instructions 622, 624, 626 to facilitate code routine performance prediction using test results from a code integration tool. As an alternative or in addition to retrieving and executing instructions, processor 610 may include one or more electronic circuits comprising a number of electronic components for performing the functionality of one or more of instructions in machine-readable storage medium 620. With respect to the executable instruction representations (e.g., boxes) described and shown herein, it should be understood that part or all of the executable instructions and/or electronic circuits included within one box may, in alternate embodiments, be included in a different box shown in the figures or in a different box not shown.

Machine-readable storage medium 620 may be any electronic, magnetic, optical, or other physical storage device that stores executable instructions. Thus, machine-readable storage medium 620 may be, for example, Random Access Memory (RAM), an Electrically-Erasable Programmable Read-Only Memory (EEPROM), a storage drive, an optical disc, and the like. Machine-readable storage medium 620 may be disposed within system 600, as shown in FIG. 6. In this situation, the executable instructions may be “installed” on the system 600. Alternatively, machine-readable storage medium 620 may be a portable, external or remote storage medium, for example, that allows system 600 to download the instructions from the portable/external/remote storage medium. In this situation, the executable instructions may be part of an “installation package”. As described herein, machine-readable storage medium 620 may be encoded with executable instructions for code routine performance prediction using test results from a code integration tool.

Referring to FIG. 6, code routine indicating instructions 622, when executed by a processor (e.g., 610), may indicate to a code integrator that a pre-written code routine should be monitored. The code integrator may merge multiple developer committed copies of code for an application and automatically run tests on the merged code. The merged code includes the pre-written code routine. Performance information receiving instructions 624, when executed by a processor (e.g., 610), may receive, from the code integrator, performance information of the pre-written code routine. The performance information may be generated in response to the tests. Performance information providing instructions 626, when executed by a processor (e.g., 610), may provide the performance information to a code development environment to display alerts or warnings to the developer when the pre-written code routine is used.

1. A system for code routine performance prediction, the system comprising:
a code integrator to merge multiple developer committed copies of code for an application and automatically run tests on the merged code, and to gather performance information of a pre-written code routine included in the merged code, wherein the performance information is generated in response to the tests;
a code routine performance manager to receive and store the performance information of the pre-written code routine; and
a code development environment to allow a developer of the application to create and modify a working copy of code for the application, and to receive the performance information of the pre-written code routine when the pre-written code routine is included in the working copy of the code.

2. The system of claim 1, wherein the code integrator is further receive, from the code routine performance manager, an indication that the code integrator is to gather performance information of the pre-written code routine.

3. The system of claim 2, wherein the code routine performance manager includes an administrator user interface that allows an administrator to determine that the code integrator is to gather performance information of the pre-written code routine, causing the indication.

4. The system of claim 1, wherein the code development environment is further to display alerts or warnings to the developer on the fly when the pre-written code routine is included in the working copy of the code or shortly after, wherein the alerts or warning are based on the performance information.

5. The system of claim 4, wherein the code development environment is to display the alerts or warnings to the developer as code analysis rule violations.

6. The system of claim 1, wherein the code integrator detects at least one use case of how the pre-written code routine is used during the tests, and categorizes the performance information according to the at least one use case.

7. The system of claim 1, wherein the code development environment allows the developer to commit the working copy of the code to be merged with the merged code by the code integrator, which causes the code integrator to automatically gather updated performance information of the pre-written code routine based on the updated merged code.

8. A method for code routine performance prediction, the method comprising:
determining, at a code routine performance manager, that a pre-written code routine should be monitored;
receiving, at a code integrator, an indication that the pre-written code routine should be monitored, wherein the code integrator is to merge multiple developer committed copies of code for an application and automatically run tests on the merged code, and wherein the merged code includes the pre-written code routine;
gathering, at the code integrator, performance information of the pre-written code routine, wherein the performance information is generated in response to the tests;
receiving and storing, at the code routine performance manager, the performance information of the pre-written code routine; and
receiving, at a code development environment, the performance information of the pre-written code routine when the pre-written code routine is included in a working copy of the code.

9. The method of claim 8, wherein the code development environment is to allow a developer of the application to create and modify the working copy of code for the application, and wherein the code development environment is further to display alerts or warnings to the developer on the fly when the pre-written code routine is included in the working copy of the code or shortly after, wherein the alerts or warning are based on the performance information.

10. The method of claim 8, wherein the determining that the pre-written code routine should be monitored is based on input from an administrator via a user interface of the a code routine performance manager.

11. The method of claim 8, wherein the gathering of the performance information of the pre-written code routine includes detecting a test use case of how the pre-written code routine is used during the tests, and categorizing the performance information according to the test use case.

12. The method of claim 11, wherein the code development environment is to detect an actual use case of how a developer of the application uses the pre-written code routine in a working copy of the code, and wherein the code development environment is further to display alerts or warnings to the developer on the fly when the actual use case matches the test use case.

13. A machine-readable storage medium encoded with instructions for code routine performance prediction, the instructions executable by a processor of a system, the instructions comprising:
code routine indicating instructions to indicate to a code integrator that a pre-written code routine should be monitored, wherein the code integrator is to merge multiple developer committed copies of code for an application and automatically run tests on the merged code, and wherein the merged code includes the pre-written code routine;
performance information receiving instructions to receive, from the code integrator, performance information of the pre-written code routine, wherein the performance information is generated in response to the tests; and
performance information providing instructions to provide the performance information to a code development environment to display alerts or warnings to the developer when the pre-written code routine is used.

14. The machine-readable storage medium of claim 13, the instructions further comprising administration user interface instructions to allow an administrator to determine that the the pre-written code routine is to be monitored.

15. The machine-readable storage medium of claim 13, wherein the performance information includes at least one of the following:
a number of times the pre-written code routine was called during the tests;
an execution time related to at least one of the times the pre-written code routine was called during the tests; and
a use case related to at least one of the times the pre-written code routine was called during the tests.
